(19) United States
(12) Patent Application Publication
(10) Pub. No.: US 2026/0341711 A1
(43) Pub. Date: Oct. 29, 2026

(54) SILICON-CARBON NEGATIVE ELECTRODE MATERIAL AND PREPARATION METHOD THEREOF AND APPLICATION THEREOF

(71) Applicant: Hoosun Technology Group Co., Ltd., Guizhou (CN)

(72) Inventors: Yuanlin LI, Shanghai (CN); Benli GONG, Sichuan (CN)

(73) Assignee: Hoosun Technology Group Co., Ltd., Guizhou (CN)

(21) Appl. No.: 19/660,006

(22) Filed: Apr. 27, 2026

Related U.S. Application Data
(63) Continuation of application No. PCT/CN2024/102998, filed on Jul. 1, 2024.

(30) Foreign Application Priority Data
Nov. 3, 2023 (CN) 202311450953.3

(51) Int. Cl. H01M 4/587

(52) U.S. Cl. CPC H01M 4/587

(57) ABSTRACT

A silicon-carbon negative electrode material and a preparation method thereof and an application thereof. The preparation method includes the following steps: conveying a silicon powder, a polyoxypropylene-polyoxyethylene copolymer and an organic solvent to a nitrogen-blanketed seal tank; dispersing same to obtain a first slurry; subjecting the first slurry to an aging treatment, a coarse grinding treatment and a fine grinding treatment to obtain a fourth slurry; mixing the fourth slurry and an organic carbon source; and subjecting the mixture to a dispersion treatment, a spray drying treatment and a sintering treatment to obtain a silicon-carbon negative electrode material. Through specific processes such as dispersion treatment, aging treatment, coarse grinding treatment and fine grinding treatment, a silicon-carbon negative electrode material with small particle size and narrow particle size distribution may be obtained, thereby improving cycling stability of a battery assembled with the silicon-carbon negative electrode material.

### CROSS-REFERENCE TO RELATED APPLICATION

The present application is a continuation of International Application No. PCT/CN2024/102998, filed on Jul. 1, 2024, which claims priority to the Chinese Patent Application No. 202311450953.3, filed with China National Intellectual Property Administration on Nov. 3, 2023. The aforementioned patent applications are hereby incorporated by reference in their entireties.

### TECHNICAL FIELD

The present application relates to the technical field of batteries, and in particular, to a silicon-carbon negative electrode material and a preparation method thereof and an application thereof.

### BACKGROUND OF RELATED ART

Metal alloy materials (such as silicon-carbon materials) are widely used as negative electrode materials in lithium-ion batteries due to their high specific capacity and high lithium-ion intercalation/de-intercalation potential. However, silicon particles in silicon-carbon materials undergo severe volume expansion during the lithium-ion intercalation process, which leads to fragmentation and pulverization of active material particles and damages the existing SEI film on the particle surface, thereby accelerating capacity degradation of a cell. Currently, reducing particle size is a primary approach to mitigate volume expansion of silicon particles, for example, by using nano-silicon particles as a raw material. However, due to high specific surface area, poor dispersion, easy agglomeration and uneven distribution of the nano-silicon particles during preparation, the resulting silicon-carbon negative electrode material has poor particle-size uniformity, thereby affecting the cycling stability of the silicon-carbon material. Therefore, how to provide a silicon-carbon material with good cycling stability is a technical problem that urgently needs to be solved in this field.

### SUMMARY OF THE INVENTION

The present application provides a silicon-carbon negative electrode material, a preparation method thereof and an application thereof. In the preparation method, by the introduction of a polyoxypropylene-polyoxyethylene copolymer in conjunction with specific processes, silicon particles with smaller particle size, narrow particle size distribution and good stability may be obtained. The silicon particles in conjunction with a carbon source with melting characteristics may achieve uniform coating, avoiding phenomena of poor dispersion and easy agglomeration of the silicon particles, and non-uniform carbon-layer coating, and thus a silicon-carbon negative electrode material with smaller particle size and narrow particle size distribution may be obtained, thereby improving the cycling stability of batteries assembled with the silicon-carbon negative electrode material. Prepared by the above preparation method, the silicon-carbon negative electrode material provided by the present application has advantages of small particle size, narrow particle size distribution, and good uniformity. When the silicon-carbon negative electrode material is applied in a battery, it is beneficial to improve the cycling stability of the battery. Because the battery provided by the present application includes the above silicon-carbon negative electrode material, the battery has excellent cycling stability.

A first aspect of the present application, provides a preparation method of a silicon-carbon negative electrode material, including the following steps:
S1: conveying a silicon powder with a Dv50 of 5 μm, a polyoxypropylene-polyoxyethylene copolymer, and an organic solvent to a nitrogen-blanketed seal tank, and dispersing them for 30 minutes at a rotation speed of 1000-1500 r/min to obtain a first slurry; where the organic solvent includes at least one of ethanol, isopropanol, tert-butanol, ethylene glycol, glycerol, or acetone;
S2: subjecting the first slurry to standing at 30-40 °C for 20-60 minutes to perform an aging treatment, to obtain a second slurry;
S3: conveying the second slurry to a coarse grinding mill, and subjecting the second slurry to a coarse grinding treatment for 5-10 hours using zirconia beads with a particle size of 0.1-0.2 mm, to obtain a third slurry; where the coarse grinding treatment is performed at a rotational speed of 3000-3400 r/min and a pressure of 1.1-1.2 bar; and silicon particles in the third slurry has a Dv50 of 100-120 nm;
S4: conveying the third slurry to an atomizer mill, and subjecting the third slurry to a fine grinding treatment for 5-10 hours using zirconia beads with a particle size of 0.03-0.05 mm, to obtain a fourth slurry; where the fine grinding treatment is performed at a rotational speed of 2000-2500 r/min and a pressure of 1.3-1.7 bar;
where the silicon particles in the fourth slurry has a Dv50 of 50-60 nm; and a ratio of Dv90 to Dv50 of the silicon particles in the fourth slurry is (1.35-1.5):1;
S5: dispersing a material including the fourth slurry and an organic carbon source at a rotational speed of 3500-4000 rpm/min and a pressure of 0.2-0.3 bar for 10 minutes to obtain a fifth slurry with a viscosity of 400-500 cps; where the organic carbon source includes at least one of asphalt, polyacrylonitrile, polyvinylpyrrolidone, phenolic resin, or epoxy resin;
S6: conveying the fifth slurry to a nitrogen-blanketed spray drying tower, and subjecting a spray drying treatment under conditions of a spray pressure of 0.01-0.1 MPa and an inlet air temperature of 200-300 °C to make the molten organic carbon source uniformly coated onto surfaces of the silicon particles, to obtain a silicon-carbon precursor; where the silicon-carbon precursor has a Dv50 of 6-14.4 μm;
S7: subjecting the silicon-carbon precursor to a sintering treatment at 800-900 °C for 2.5-3.5 hours, to obtain a silicon-carbon negative electrode material; where silicon-carbon negative electrode material has a Dv50 of 5-12 μm, and a ratio of Dv90 to Dv50 of the silicon-carbon negative electrode material is (1.36-1.49):1;
where Dv50 represents a particle size at which a cumulative volume fraction reaches 50%, and Dv90 represents a particle size at which the cumulative volume fraction reaches 90%.

The preparation method as described above, where,
in the first slurry, based on that a total mass of the first slurry is 100% by mass, a content of the silicon powder is 5.5%-15% by mass;
in the first slurry, based on that a total mass of the first slurry is 100% by mass, a content of the polyoxypropylene-polyoxyethylene copolymer is 0.15%-1.5% by mass;
a mass ratio of the silica powder to the organic carbon source is (3-7):(3-7).

The preparation method as described above, where an outlet temperature of the spray drying is 60-80 °C.

The preparation method as described above, where after the sintering treatment, the preparation method further includes a pulverizing treatment and a sieving treatment.

The preparation method as described above, where in the step S5, the material further includes carbon nanotubes.

The preparation method as described above, where a mass ratio of the carbon nanotubes to the organic carbon source is 1:(1-2).

The preparation method as described above, where a weight average molecular weight of the polyoxypropylene-polyoxyethylene copolymer is 1000-1500.

The preparation method as described above, after the fourth slurry is left to stand for 2 days, a change rate of Dv50 of the fourth slurry is not higher than 3%; and after the fourth slurry is left to stand for 6 days, the change rate of Dv50 of the fourth slurry is not higher than 5%.

A second aspect of the present application provides a silicon-carbon negative electrode material obtained by the preparation method as described in the first aspect.

A third aspect of the present application provides a battery including the silicon-carbon negative electrode material as described in the second aspect.

Implementation of the present application provides at least the following beneficial effects.

In the preparation method of the silicon-carbon negative electrode material provided by the present application, the polyoxypropylene-polyoxyethylene copolymer may form a hydrophobic layer on the surface of each silicon powder particle, and may form a micelle to encapsulate the silicon particle through a cross-linking structure of molecules, effectively isolating interaction forces between silicon particles, thereby preventing the formation of agglomeration. This is conducive to improving dispersibility and stability of the silicon particles, ensuring uniform distribution of the silicon particles in the material. At the same time, through specific processes such as dispersion treatment, aging treatment, coarse grinding treatment, and fine grinding treatment, it is beneficial to obtain silicon particles with small particle size, narrow particle size distribution, and good stability. The silicon particles in conjunction with a carbon source with melting characteristics may achieve uniform coating, and thus a silicon-carbon negative electrode material with small particle size and narrow particle size distribution may be obtained, thereby improving the cycling stability of batteries assembled with the silicon-carbon negative electrode material.

### BRIEF DESCRIPTION OF THE DRAWINGS

FIG. 1 is a flowchart of a preparation method of a silicon-carbon negative electrode material according to one embodiment of the present application.

FIG. 2 is a SEM image of a third slurry in Example 1 of the present application.

FIG. 3 is a SEM image of a second slurry in Comparative Example 2 of the present application.

### DETAILED DESCRIPTION OF THE EMBODIMENTS

To make the object, technical solutions and advantages of the present application clearer, the following provides a clear and complete description of the present application. Obviously, the embodiments described below are only part of the embodiments of the present application, not all of the embodiments. All other embodiments obtained by those skilled in the art based on the embodiments of the present application without any creative labor are within the scope of protection of the present application.

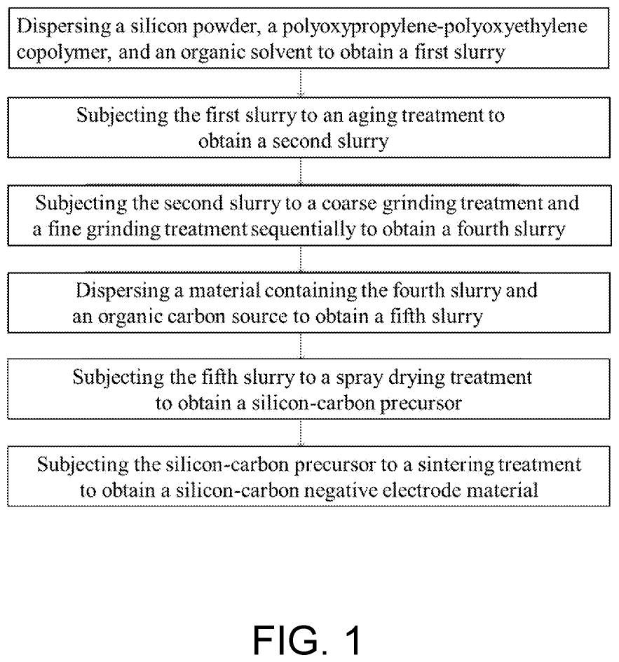

As shown in FIG. 1, the first aspect of the present application provides a preparation method of a silicon-carbon negative electrode material, including the following steps:
S1: conveying a silicon powder with a Dv50 of 5 μm, a polyoxypropylene-polyoxyethylene copolymer, and an organic solvent to a nitrogen-blanketed seal tank, and dispersing them for 30 minutes at a rotation speed of 1000-1500 r/min to obtain a first slurry; where the organic solvent includes at least one of ethanol, isopropanol, tert-butanol, ethylene glycol, glycerol, or acetone;
S2: subjecting the first slurry to standing at 30-40 °C for 20-60 minutes to perform an aging treatment, to obtain a second slurry;
S3: conveying the second slurry to a coarse grinding mill, and subjecting the second slurry to a coarse grinding treatment for 5-10 hours using zirconia beads with a particle size of 0.1-0.2 mm, to obtain a third slurry; where the coarse grinding treatment is performed at a rotational speed of 3000-3400 r/min and a pressure of 1.1-1.2 bar; and silicon particles in the third slurry has a Dv50 of 100-120 nm;
S4: conveying the third slurry to an atomizer mill, and subjecting the third slurry to a fine grinding treatment for 5-10 hours using zirconia beads with a particle size of 0.03-0.05 mm, to obtain a fourth slurry; where the fine grinding treatment is performed at a rotational speed of 2000-2500 r/min and a pressure of 1.3-1.7 bar; the silicon particles in the fourth slurry have a Dv50 of 50-60 nm; and a ratio of Dv90 to Dv50 of the silicon particles in the fourth slurry is (1.35-1.5):1;
S5: dispersing a material including the fourth slurry and an organic carbon source at a rotational speed of 3500-4000 rpm/min and a pressure of 0.2-0.3 bar for 10 minutes to obtain a fifth slurry with a viscosity of 400-500 cps; where the organic carbon source includes at least one of asphalt, polyacrylonitrile, polyvinylpyrrolidone, phenolic resin, or epoxy resin;
S6: conveying the fifth slurry to a nitrogen-blanketed spray drying tower, and subjecting a spray drying treatment under conditions of a spray pressure of 0.01-0.1 MPa and an inlet air temperature of 200-300 °C to make the molten organic carbon source uniformly coated onto the surfaces of the silicon particles, to obtain a silicon-carbon precursor; where the silicon-carbon precursor has a Dv50 of 6-14.4 μm;
S7: subjecting the silicon-carbon precursor to a sintering treatment at 800-900 °C for 2.5-3.5 hours, to obtain a silicon-carbon negative electrode material; where the silicon-carbon negative electrode material has a Dv50 of 5-12 μm, and a ratio of Dv90 to Dv50 of the silicon-carbon negative electrode material is (1.36-1.49):1. Where, Dv50 represents a particle size at which a cumulative volume fraction reaches 50%, and Dv90 represents a particle size at which the cumulative volume fraction reaches 90%. The polyoxypropylene-polyoxyethylene copolymer dissolves in an organic solvent, and the polyoxypropylene-polyoxyethylene copolymer contains polyoxyethylene (PEO) segments and polyoxypropylene (PPO) segments, with a chemical formula of HO(C₂H₄O) m(C₃H₆O) nH, where m>0 and n>0. The PEO segments have hydrophilic property, while the PPO segments have hydrophobic property.

During a specific preparation process, by precisely controlling equipment parameters, an addition ratio and timing of reaction raw materials, efficient pulverization and uniform dispersion of silicon particles are achieved, which is conducive to obtaining a silicon-carbon negative electrode material with small particle size, narrow particle size distribution, and good uniformity.

In the present application, the PEO segments in the first slurry interact with an organic solvent to form a hydrophilic layer, while the PPO segments interacts with the surface of each silica powder particle to form a hydrophobic layer, and thus interaction forces between silica particles are effectively isolated, thereby preventing the formation of agglomeration; furthermore, polyoxypropylene-polyoxyethylene copolymer molecules form micellar structures encapsulating the silicon powder particles respectively under an influence of the organic solvent. Such micellar structures, composed of both PEO and PPO segments, may encapsulate the silicon particles, providing an optimal dispersion environment, improving dispersion efficiency, and ensuring uniform distribution of silicon powder particles within the material, thereby contributing to the improvement of cycling stability of the silicon-carbon negative electrode material. Therefore, the polyoxypropylene-polyoxyethylene copolymer introduced in the present application may effectively suppresses particle agglomeration through a dual dispersion mechanism of forming a hydrophobic layer and chemical encapsulation.

A first slurry is subjected to standing at 30-40 °C for 20-60 minutes to undergo an aging treatment to cause respective components in the first slurry to fully react for improving the stability of the first slurry, thereby obtaining a second slurry with excellent stability.

The second slurry is subjected to a grinding treatment, which is conducive to obtaining silicon particles with small particle size and narrow distribution. Grading of particle sizes of the silicon particles in the slurry could be measured using a laser particle size analyzer. Because of the presence of the polyoxypropylene-polyoxyethylene copolymer, the agglomeration of the silicon particles due to their excessively small size during subsequent processes may be avoided, thereby ensuring uniform distribution. Specifically, in the present application, coarse grinding is performed under conditions of a relatively high rotational speed (3000-3400 r/min), a relatively low pressure (1.1-1.2 bar), and a larger zirconia bead size (0.1-0.2 mm). Subsequently, the rotational speed is reduced (2000-2500 r/min), the pressure is increased (1.3-1.7 bar), and the zirconia bead size is decreased (0.03-0.05 mm) to perform a fine grinding treatment. Through the coarse and fine grinding treatments, the average particle size of the silicon particles may be decreased from 3-5 μm to 100-120 nm, then from 100-120 nm to 50-60 nm. Compared with one-step ball milling, this method is less prone to agglomeration and may improve the stability and dispersion of the silicon particles in the slurry, thereby improving the uniformity of the silicon-carbon negative electrode material.

Furthermore, in Step S3, a discharge temperature of the third slurry is controlled between 40-45 °C, with cooling water temperature maintained at 8-12 °C. In Step S4, a discharge temperature of the fourth slurry is controlled between 40-45 °C, with cooling water temperature of equipment maintained at 8-12 °C.

In Step S5, a material including the fourth slurry and an organic carbon source is conveyed to an IMS online dispersion equipment, and is dispersed for 10 minutes at a rotational speed of 3500-4000 rpm/min and a pressure of 0.2-0.3 bar under a condition of nitrogen protection. The IMS online dispersion equipment (Intelligence Mixing System) is an online dispersion system for powders and liquids. It produces high-speed flow by pumping a liquid, thereby creating a powerful vacuum in a dispersion zone. The vacuum suction allows a powder from powder tank trucks, silos, bags, or bulk bags to be drawn directly and losslessly. The powder is then thoroughly dispersed and mixed with the liquid.

In step S6, due to the molten characteristic of the organic carbon source, the organic carbon source is in a flowing state in a spray drying tower, and the molten organic carbon source may be uniformly coated onto the surfaces of silicon particles with small particle size and narrow size distribution, and thus a silicon-carbon precursor with a Dv50 of 6-14.4 μm is obtained. This is conducive to obtaining a silicon-carbon negative electrode material with small particle size and narrow size distribution in the subsequent processes, thereby improving the uniformity.

It should be noted that during the process of spray drying, the organic solvent evaporates, while the organic carbon source and polyoxypropylene-polyoxyethylene copolymer are simultaneously coated onto the surfaces of silicon particles. In other words, the silicon-carbon precursor includes the silicon particles as well as the polyoxypropylene-polyoxyethylene copolymer and organic carbon source coated on the surfaces of the silicon particles. Dv50 of the silicon-carbon precursor refers to Dv50 of a structure having the silicon particles being coated with the polyoxypropylene-polyoxyethylene copolymer and organic carbon source.

The organic carbon source includes bitumen and an organic polymer; the organic polymer includes at least one of polyacrylonitrile (PAN), polyvinylpyrrolidone (PVP), a phenolic resin, and an epoxy resin.

The silicon-carbon precursor is subjected to a sintering treatment at 800-900 °C for 2.5-3.5 hours for performing a carbonization treatment on the polyoxypropylene-polyoxyethylene copolymer and the organic carbon source, to obtain a silicon-carbon negative electrode material with a Dv50 of 5-12 μm. The silicon-carbon negative electrode material has advantages of small particle size, narrow size distribution, and high uniformity. At this point, the silicon-carbon negative electrode material includes the silicon particle and a carbon layer coating on the surface of the silicon particle. The carbon layer is obtained through the carbonization treatment of the polyoxypropylene-polyoxyethylene copolymer and the organic carbon source. Dv50 of the silicon-carbon negative electrode material refers to Dv50 of the silicon particle structure that is coated with the carbon layer.

Where, the sintering treatment is performed at a temperature of 800-900 °C, such as 800 °C, 850 °C, 900 °C or in a range consisting of any two values thereof, and the sintering treatment is performed for 2.5-3.5 hours, such as 2.5 hours, 3 hours, 3.5 hours or in a range consisting of any two values thereof.

According to the research on the present application, a battery assembled with the silicon-carbon negative electrode material prepared by the aforementioned method exhibits excellent cycling stability. This is because, on the one hand, the function of the polyoxypropylene-polyoxyethylene copolymer and the organic solvent, in conjunction with specific dispersion treatment, aging treatment, coarse grinding treatment, and fine grinding treatment is conducive to the improvement of the dispersion and stability of silicon particles. This ensures uniform distribution of the silicon particles in the material, thereby obtaining the silicon particles with small particle size, narrow particle size distribution, and good stability, and thus facilitating the production of the silicon-carbon negative electrode material with good uniformity; meanwhile, the use of the organic carbon source as a coating material for the silicon particles, as well as the use of spray drying to make the molten organic carbon source uniformly coated onto the surfaces of the silicon particles are conducive to the improvement of uniformity of coating of the carbon layer, thereby effectively preventing the fragmentation of the silicon particles, and thus ensuring the cycle stability and structural stability of the silicon-carbon negative electrode material.

The present application does not limit reaction raw materials and amounts of respective components. For example, the organic solvent includes at least one of ethanol, isopropanol, tert-butanol, ethylene glycol, glycerol and acetone; the silicon powder in the first slurry has a mass content of 5.5%-15%, such as 5.5%, 6%, 7%, 7.5%, 8%, 9%, 10%, 11%, 12%, 13%, 14%, 15% or in a range composed of any two value thereof; the polyoxypropylene polyoxyethylene copolymer in the first slurry has a mass concentration of 0.15%-1.5%, such as 0.15%, 0.20%, 0.30%, 0.40%, 0.50%, 0.60%, 0.70%, 0.80%, 0.90%, 1.0%, 1.1%, 1.2%, 1.3%, 1.4%, 1.5% or in a range composed of any two value.

In some embodiments, in the step S5, the material further includes carbon nanotubes. That is, the material including the fourth slurry, the organic carbon source, and the carbon nanotubes is dispersed for 10 minutes at a rotational speed of 3500-4000 rpm/min and a pressure of 0.2-0.3 bar, to obtain a fifth slurry with a viscosity of 400-500 cps. The fifth slurry is subjected to a spray drying treatment, to obtain a silicon-carbon precursor. The silicon-carbon precursor includes silicon particles, the organic carbon source uniformly coated onto the surfaces of the silicon particles, and the carbon nanotubes embedded within the organic carbon source. The carbon nanotubes serve a supplementary role, and is conducive to improving the conductivity of the silicon-carbon negative electrode material and thereby improving the electrochemical performance of the battery. After a sintering treatment, the organic carbon source forms a carbon layer on the surface of each silicon particle, with carbon nanotubes embedded within the carbon layer. The carbon layer and the carbon nanotubes not only enhance the conductivity of the material but also prevent the silicon particles from being fragmented and scattered, thereby effectively avoiding cracking and pulverization of the silicon-carbon negative electrode material due to volume changes during the charge-discharge process, and thus ensuring the cycling stability and structural stability of the silicon-carbon negative electrode material; additionally, they can reduce the direct contact between the silicon particles and an electrolyte, improving electrode/electrolyte interface compatibility and thereby enhancing cycling performance.

A mass ratio of the carbon nanotubes to the organic carbon source is 1:(1-2), such as 1:1, 1:1.5, 1:2, or in a range composed of any two values thereof.

In some embodiments, an outlet temperature of the spray drying process is 60-80 °C. In some embodiments, after the sintering treatment, grinding and sieving treatments are included. In some embodiments, a weight-average molecular weight of the polyoxypropylene-polyoxyethylene copolymer is 1000-1500. In some embodiments, after the fourth slurry is left to stand for 2 days, a change rate of Dv50 of the fourth slurry is no higher than 3%; after the fourth slurry is left to stand for 6 days, the change rate of Dv50 of the fourth slurry is no higher than 5%.

A second aspect of the present application provides a silicon-carbon negative electrode material prepared using the method of the first aspect. The silicon-carbon negative electrode material is a core-shell structure with each silicon particle coated by a carbon layer. Due to being prepared by the method of the first aspect, the silicon-carbon negative electrode material has small particle size, narrow particle size distribution, and good uniformity, and thus exhibits excellent electrical conductivity and cycling stability.

A third aspect of the present application provides a battery including the silicon-carbon negative electrode material of the second aspect. Specifically, the silicon-carbon negative electrode material is coated onto a current collector, and subjected to drying and cutting, to obtain a negative electrode sheet, where the current collector may be a copper foil.

The above battery further includes a positive electrode sheet and a separator. A preparation method for the battery includes the following steps: assembling the negative electrode sheet with the separator and positive electrode sheet to form a button battery or pouch battery, thereby producing the battery.

The present application is further illustrated through specific embodiments and comparative examples below. Unless otherwise specified, reagents, materials, and instruments used herein are conventional reagents, materials, and instruments, all commercially available. The involved reagents and materials may also be synthesized via conventional methods. The selected raw materials are shown in Table 1 and as follows.

TABLE 1

| | | Molecular | |
|---|---|---|---|
| | CAS | weight | |
| Raw material | Number | Mw | Source of Purchase |
| Asphalt | 68201-32-1 | 1800 | Hebei Junsheng New |
| | | | Materials Technology |
| | | | Co., Ltd |
| Polyacrylonitrile | 25014-41-9 | 90000 | Shanghai Aladdin |
| | | | Biochemical |
| | | | Technology Co., Ltd. |
| Polyvinylpyrrolidone | 9003-39-8 | 30000 | Shanghai Aladdin |
| | | | Biochemical |
| | | | Technology Co., Ltd. |
| Phenolic resin | 9003-35-4 | 4000 | Shanghai Aladdin |
| | | | Biochemical |
| | | | Technology Co., Ltd. |
| Polyoxypropylene- | 9003-11-6 | 1100 | Shaanxi |
| polyoxyethylene | | | Yangyuanshen |
| copolymer | | | Biotechnology Co., |
| | | | Ltd |
| Epoxy resin | 61788-97-4 | 5000 | Shandong Luxing |
| | | | Chemical Co., Ltd. |

A graphite sheet with CAS number of 7782-42-5 and a molecular weight of 12 is purchased from Shanghai Shanshan Technology Co., Ltd.; a carbon nanotube with CAS number of 308068-56-6 and a molecular weight of 12 is purchased from Shanghai Aladdin Biochemical Technology Co., Ltd.

### Example 1

A preparation method of a silicon-carbon negative electrode material in the present embodiment includes the following steps:
(1) mixing 130 g of a silicon powder (Dv50 is 5 μm) with 1603 g of ethanol, adding a polyoxypropylene-polyoxyethylene copolymer, and conveying the mixture to a nitrogen-blanketed seal tank with nitrogen protection, and dispersing the mixture for 30 minutes at a rotation speed of 1000 r/min to obtain a first slurry; at this point, a mass content of the silicon powder in the first slurry is 7.5%, and a mass concentration of the polyoxypropylene-polyoxyethylene copolymer is 0.15%;
(2) subjecting the first slurry to standing at 30 °C for 60 minutes to perform an aging treatment to obtain a second slurry;
(3) conveying the second slurry to a coarse grinding mill, and subjecting the second slurry to a coarse grinding treatment for 8 hours using zirconia beads with a particle size of 0.1 mm, to obtain a third slurry in which silicon particles have a Dv50 of 100 nm; where the coarse grinding treatment is performed at a rotational speed of 3400 r/min and a pressure of 1.2 bar;
(4) conveying the third slurry to an atomizer mill, and subjecting the third slurry to a fine grinding treatment for 8 hours using zirconia beads with a particle size of 0.03 mm, to obtain a fourth slurry in which the silicon particles have a Dv50 of 51 nm; where the fine grinding treatment is performed at a rotational speed of 2500 r/min and a pressure of 1.7 bar;
(5) dispersing the fourth slurry and 55.7 g of asphalt at a rotational speed of 4000 rpm/min and a pressure of 0.2 bar for 10 minutes to obtain a fifth slurry with a viscosity of 410 cps;
(6) conveying the fifth slurry to a nitrogen-blanketed spray drying tower, and performing a spray drying treatment under conditions of a spray pressure of 0.1 MPa and an inlet air temperature of 250 °C to make molten asphalt uniformly coated on surfaces of the silicon particles, to obtain a silicon-carbon precursor;
(7) subjecting the silicon-carbon precursor to a calcination treatment at 850 °C for 3 hours under nitrogen protection, to obtain the silicon-carbon negative electrode material.

### Example 2

A preparation method of a silicon-carbon negative electrode material in the present embodiment includes the following steps:
(1) mixing 130 g of a silicon powder (Dv50 is 5 μm) with 1170 g of isopropanol, adding a polyoxypropylene-polyoxyethylene copolymer, and conveying the mixture to a nitrogen-blanketed seal tank, and dispersing the mixture for 30 minutes at a rotation speed of 1500 r/min to obtain a first slurry; at this point, a mass content of the silicon powder in the first slurry is 10% and a mass concentration of the polyoxypropylene-polyoxyethylene copolymer is 0.6%;
(2) subjecting the first slurry to standing at 40 °C for 20 minutes to perform an aging treatment to obtain a second slurry;
(3) conveying the second slurry to a coarse grinding mill, and subjecting the second slurry to a coarse grinding treatment for 10 hours using zirconia beads with a particle size of 0.2 mm, to obtain a third slurry in which silicon particles have a Dv50 of 110 nm; where the coarse grinding treatment is performed at a rotational speed of 3000 r/min and a pressure of 1.1 bar;
(4) conveying the third slurry to an atomizer mill, and subjecting the third slurry to a fine grinding treatment for 8 hours using zirconia beads with a particle size of 0.05 mm, to obtain a fourth slurry in which the silicon particles have a Dv50 of 58 nm; where the fine grinding treatment is performed at a rotational speed of 2000 r/min and a pressure of 1.3 bar; and a ratio of Dv90 to Dv50 of the silicon particles in the fourth slurry is 1.35:1;
(5) dispersing the fourth slurry and 303 g of asphalt at a rotational speed of 3500 rpm/min and a pressure of 0.3 bar for 10 minutes to obtain a fifth slurry with a viscosity of 482 cps;
(6) conveying the fifth slurry to a nitrogen-blanketed spray drying tower, and performing a spray drying treatment under conditions of a spray pressure of 0.05 MPa and an inlet air temperature of 300 °C to make molten asphalt uniformly coated on surfaces of the silicon particles, to obtain a silicon-carbon precursor;
(7) subjecting the silicon-carbon precursor to a calcination treatment at 850 °C for 3 hours under nitrogen protection, to obtain the silicon-carbon negative electrode material.

### Example 3

A preparation method of a silicon-carbon negative electrode material in the present embodiment includes the following steps:
(1) mixing 130 g of a silicon powder (Dv50 is 5 μm) with 910 g of tert-butanol, adding a polyoxypropylene-polyoxyethylene copolymer, and conveying the mixture to a nitrogen-blanketed seal tank, and dispersing the mixture for 30 minutes at a rotation speed of 1200 r/min to obtain a first slurry; at this point, a mass content of the silicon powder in the first slurry is 12.5% and a mass concentration of the polyoxypropylene-polyoxyethylene copolymer is 1.25%;
(2) subjecting the first slurry to standing at 35 °C for 40 minutes to perform an aging treatment to obtain a second slurry;
(3) conveying the second slurry to a coarse grinding mill, and subjecting the second slurry to a coarse grinding treatment for 6 hours using zirconia beads with a particle size of 0.2 mm, to obtain a third slurry in which silicon particles have a Dv50 of 112 nm; where the coarse grinding treatment is performed at a rotational speed of 3200 r/min and a pressure of 1.1 bar;
(4) conveying the third slurry to an atomizer mill, and subjecting the third slurry to a fine grinding treatment for 7 hours using zirconia beads with a particle size of 0.04 mm, to obtain a fourth slurry in which the silicon particles have a Dv50 of 56 nm; where the fine grinding treatment is performed at a rotational speed of 2400 r/min and a pressure of 1.5 bar; and a ratio of Dv90 to Dv50 of the silicon particles in the fourth slurry is 1.45:1;
(5) dispersing the fourth slurry and 87 g of an epoxy resin at a rotational speed of 3800 rpm/min and a pressure of 0.3 bar for 10 minutes to obtain a fifth slurry with a viscosity of 462 cps;
(6) conveying the fifth slurry to a nitrogen-blanketed spray drying tower, and performing a spray drying treatment under conditions of a spray pressure of 0.1 MPa and an inlet air temperature of 300 °C to make molten epoxy resin uniformly coated on surfaces of the silicon particles, to obtain a silicon-carbon precursor;
(7) subjecting the silicon-carbon precursor to a calcination treatment at 850 °C for 3 hours under nitrogen protection, to obtain the silicon-carbon negative electrode material.

### Example 4

A preparation method of a silicon-carbon negative electrode material in the present embodiment includes the following steps:
(1) mixing 130 g of a silicon powder (Dv50 is 5 μm) with 736 g of tert-butanol, adding a polyoxypropylene-polyoxyethylene copolymer, and conveying the mixture to a nitrogen-blanketed seal tank, and dispersing the mixture for 30 minutes at a rotation speed of 1300 r/min to obtain a first slurry; at this point, a mass content of the silicon powder in the first slurry is 15% and a mass concentration of the polyoxypropylene-polyoxyethylene copolymer is 0.3%;
(2) subjecting the first slurry to standing at 40 °C for 20 minutes to perform an aging treatment to obtain a second slurry;
(3) conveying the second slurry to a coarse grinding mill, and subjecting the second slurry to a coarse grinding treatment for 5 hours using zirconia beads with a particle size of 0.1 mm, to obtain a third slurry in which silicon particles have a Dv50 of 105 nm; where the coarse grinding treatment is performed a rotational speed of 3200 r/min and a pressure of 1.1 bar;
(4) conveying the third slurry to an atomizer mill, and subjecting the third slurry to a fine grinding treatment for 9 hours using zirconia beads with a particle size of 0.03 mm, to obtain a fourth slurry in which the silicon particles have a Dv50 of 52 nm; where the fine grinding treatment is performed at a rotational speed of 2000 r/min and a pressure of 1.3 bar; and a ratio of Dv90 to Dv50 of the silicon particles in the fourth slurry is 1.5:1;
(5) dispersing the fourth slurry and 87 g of a phenolic resin at a rotational speed of 3500 rpm/min and a pressure of 0.3 bar for 10 minutes to obtain a fifth slurry with a viscosity of 414 cps;
(6) conveying the fifth slurry to a nitrogen-blanketed spray drying tower, and performing a spray drying treatment under conditions of a spray pressure of 0.1 MPa and an inlet air temperature of 300 °C to make molten phenolic resin uniformly coated on surfaces of the silicon particles, to obtain a silicon-carbon precursor;
(7) subjecting the silicon-carbon precursor to a calcination treatment at 850 °C for 3 hours under nitrogen protection, to obtain the silicon-carbon negative electrode material.

### Example 5

A preparation method of a silicon-carbon negative electrode material in the present embodiment includes the following steps:
(1) mixing 20 g of a silicon powder (Dv50 is 5 μm) with 350 ml of glycerol, adding a polyoxypropylene-polyoxyethylene copolymer, and conveying the mixture to a nitrogen-blanketed seal tank, and dispersing the mixture for 30 minutes at a rotation speed of 1500 r/min to obtain a first slurry; at this point, a mass content of the silicon powder in the first slurry is 5.5% and a mass concentration of the polyoxypropylene-polyoxyethylene copolymer is 0.33%;
(2) subjecting the first slurry to standing at 40 °C for 20 minutes to perform an aging treatment to obtain a second slurry;
(3) conveying the second slurry to a coarse grinding mill, and subjecting the second slurry to a coarse grinding treatment for 9 hours using zirconia beads with a particle size of 0.2 mm, to obtain a third slurry in which silicon particles have a Dv50 of 109 nm; where the coarse grinding treatment is performed at a rotational speed 3000 r/min and a pressure of 1.1 bar;
(4) conveying the third slurry to an atomizer mill, and subjecting the third slurry to a fine grinding treatment for 5 hours using zirconia beads with a particle size of 0.05 mm, to obtain a fourth slurry in which the silicon particles have a Dv50 of 58 nm; where the fine grinding treatment is performed at a rotational speed 2000 r/min and a pressure of 1.3 bar; and a ratio of Dv90 to Dv50 of the silicon particles in the fourth slurry is 1.37:1;
(5) dispersing the fourth slurry and 20 g of polyvinylpyrrolidone at a rotational speed of 3500 rpm/min and a pressure of 0.3 bar for 10 minutes to obtain a fifth slurry with a viscosity of 485 cps;
(6) conveying the fifth slurry to a nitrogen-blanketed spray drying tower, and performing a spray drying treatment under conditions of a spray pressure of 0.1 MPa and an inlet air temperature of 300 °C to make molten polyvinylpyrrolidone uniformly coated on surfaces of the silicon particles, to obtain a silicon-carbon precursor;
(7) subjecting the silicon-carbon precursor to a calcination treatment at 850 °C for 3 hours under nitrogen protection, to obtain the silicon-carbon negative electrode material.

### Example 6

A preparation method of a silicon-carbon negative electrode material in the present embodiment includes the following steps:
(1) mixing 20 g of a silicon powder (Dv50 is 5 μm) with 350 ml of acetone, adding a polyoxypropylene-polyoxyethylene copolymer, and conveying the mixture to a nitrogen-blanketed seal tank, and dispersing the mixture for 30 minutes at a rotation speed of 1500 r/min to obtain a first slurry; at this point, a mass content of the silicon powder in the first slurry is 5.5% and a mass concentration of the polyoxypropylene-polyoxyethylene copolymer is 0.25%;
(2) subjecting the first slurry to standing at 40 °C for 20 minutes to perform an aging treatment to obtain a second slurry;
(3) conveying the second slurry to a coarse grinding mill, and subjecting the second slurry to a coarse grinding treatment for 10 hours using zirconia beads with a particle size of 0.2 mm, to obtain a third slurry in which silicon particles have a Dv50 of 110 nm; where the coarse grinding treatment is performed at a rotational speed of 3000 r/min and a pressure of 1.1 bar;
(4) conveying the third slurry to an atomizer mill, and subjecting the third slurry to a fine grinding treatment for 4 hours using zirconia beads with a particle size of 0.05 mm, to obtain a fourth slurry in which the silicon particles have a Dv50 of 55 nm; where the fine grinding treatment is performed at a rotational speed of 2000 r/min and a pressure of 1.3 bar; and a ratio of Dv90 to Dv50 of the silicon particles in the fourth slurry is 1.36:1;
(5) dispersing the fourth slurry and 20 g of polyacrylonitrile at a rotational speed of 3500 rpm/min and a pressure of 0.3 bar for 10 minutes to obtain a fifth slurry with a viscosity of 443 cps;
(6) conveying the fifth slurry to a nitrogen-blanketed spray drying tower, and performing a spray drying treatment under conditions of a spray pressure of 0.01 MPa and an inlet air temperature of 300 °C to make molten polyacrylonitrile uniformly coated on surfaces of the silicon particles, to obtain a silicon-carbon precursor;
(7) subjecting the silicon-carbon precursor to a calcination treatment at 850 °C for 3 hours under nitrogen protection, to obtain the silicon-carbon negative electrode material.

### Example 7

A preparation method is basically the same as that of Example 1. The difference lies in that in step (5), “55.7 g of asphalt” is changed to “55.7 g of asphalt and 28 g of carbon nanotubes”, while all other conditions remain unchanged.

### Comparative Example 1

(1) Mixing 130 g of a silicon powder (with an average particle size of 5 μm) with 1603 g of ethanol, to obtain a first slurry; at this point, a mass content of the silicon powder in the first slurry is 7.5%;
(2) subjecting the first slurry to grinding in a 0.5 L sand grinding jar at a grinding speed of 3200 rpm using grinding balls having a diameter of 0.1 mm for 12 hours, to obtain a second slurry; silica particles in the second slurry have a Dv50 of 70 nm, and the silica particles in the second slurry have a Dv90 of 112 nm;
(3) mixing the second slurry with a polyoxypropylene-polyoxyethylene copolymer, to obtain a mixing slurry, where a mass content of the polyoxypropylene-polyoxyethylene copolymer in the mixing slurry is 6%;
(4) mixing the mixing slurry with 55.7 g of asphalt, and performing a spray drying treatment at a temperature of 240 °C under nitrogen protection, with an outlet air temperature of 60 °C, to obtain a silicon-carbon source composite material; subjecting the silicon-carbon source composite material to a calcination treatment at 850 °C for 3 hours under nitrogen protection, to obtain a silicon-carbon negative electrode material.

### Comparative Example 2

(1) Mixing 130 g of a silicon powder (with an average particle size of 5 μm) with 1170 g of ethanol, to obtain a first slurry; at this point, a mass content of the silicon powder in the first slurry is 10%;
(2) subjecting the first slurry to grinding in a 0.5 L sand grinding jar at a grinding speed of 3200 rpm using grinding balls having a diameter of 0.1 mm for 17 hours, to obtain a second slurry; where silica particles in the second slurry has a Dv50 of 75 nm, and the silica particles in the second slurry have a Dv90 of 118 nm;
(3) mixing the second slurry with 55 g of asphalt, and performing a spray drying treatment at a temperature of 240 °C under nitrogen protection, with an outlet air temperature of 60 °C, to obtain a silicon-carbon source composite material; subjecting the silicon-carbon source composite material to a calcination treatment at 850 °C for 3 hours under nitrogen protection, to obtain a silicon-carbon negative electrode material.

### Comparative Example 3

A preparation method is basically the same as that of Example 1. The difference lies in the absence of step (2), and the first slurry is directly subjected to step (3), while other conditions remain unchanged. Specifically:
(1) mixing 130 g of a silicon powder (Dv50 is 5 μm) with 1603 g of ethanol, adding a polyoxypropylene-polyoxyethylene copolymer, and conveying the mixture to a nitrogen-blanketed seal tank, and dispersing the mixture for 30 minutes at a rotation speed of 1000 r/min to obtain a first slurry; at this point, a mass content of the silicon powder in the first slurry is 7.5%, and a mass concentration of the polyoxypropylene-polyoxyethylene copolymer is 0.15%;
(2) conveying the first slurry to a coarse grinding mill, and subjecting the first slurry to a coarse grinding treatment for 8 hours using zirconia beads with a particle size of 0.1 mm, to obtain a second slurry in which silicon particles have a Dv50 of 140 nm; where the coarse grinding treatment is performed at a rotational speed of 3400 r/min and a pressure of 1.2 bar;
(3) conveying the second slurry to an atomizer mill, and subjecting the second slurry to a fine grinding treatment for 8 hours using zirconia beads with a particle size of 0.03 mm, to obtain a third slurry in which the silicon particles have a Dv50 of 65 nm and a Dv90 of 104 nm; where the fine grinding treatment is performed at a rotational speed of 2500 r/min and a pressure of 1.7 bar;
(4) dispersing the third slurry and 55.7 g of asphalt at a rotational speed of 4000 rpm/min and a pressure of 0.2 bar for 10 minutes to obtain a fourth slurry with a viscosity of 532 cps;
(5) conveying the fourth slurry to a nitrogen-blanketed spray drying tower, and performing a spray drying treatment under conditions of a spray pressure of 0.1 MPa and an inlet air temperature of 250 °C to make molten asphalt uniformly coated on surfaces of the silicon particles, to obtain a silicon-carbon precursor;
(6) subjecting the silicon-carbon precursor to a calcination treatment at 850 °C for 3 hours under nitrogen protection, to obtain a silicon-carbon negative electrode material.

### Comparative Example 4

A preparation method is basically the same as that of Example 1. The difference lies in step (3): the coarse grinding treatment is performed by using zirconia beads with a particle size of 0.5 mm at a rotational speed of 2000 r/min, while other conditions remain unchanged. Specifically:
(1) mixing 130 g of a silicon powder (Dv50 is 5 μm) with 1603 g of ethanol, adding a polyoxypropylene-polyoxyethylene copolymer, and conveying the mixture to a nitrogen-blanketed seal tank, and dispersing the mixture for 30 minutes at a rotation speed of 1000 r/min to obtain a first slurry; at this point, a mass content of the silicon powder in the first slurry is 7.5%, and a mass concentration of the polyoxypropylene-polyoxyethylene copolymer is 0.15%;
(2) subjecting the first slurry to standing at 30 °C for 60 minutes to perform an aging treatment, to obtain a second slurry;
(3) conveying the second slurry to a coarse grinding mill, and subjecting the second slurry to a coarse grinding treatment for 8 hours using zirconia beads with a particle size of 0.5 mm, to obtain a third slurry in which silicon particles have a Dv50 of 155 nm; where the coarse grinding treatment is performed at a rotational speed of 2000 r/min and a pressure of 1.2 bar;
(4) conveying the third slurry to an atomizer mill, and subjecting the third slurry to a fine grinding treatment for 8 hours using zirconia beads with a particle size of 0.03 mm, to obtain a fourth slurry in which the silicon particles have a Dv50 of 80 nm and a Dv90 of 122 nm; where the fine grinding treatment is performed at a rotational speed of 2500 r/min and a pressure of 1.7 bar
(5) dispersing the fourth slurry and 55.7 g of asphalt at a rotational speed of 4000 rpm/min and a pressure of 0.2 bar for 10 minutes to obtain a fifth slurry with a viscosity of 570 cps;
(6) conveying the fifth slurry to a nitrogen-blanketed spray drying tower, and performing a spray drying treatment under conditions of a spray pressure of 0.1 MPa and an inlet air temperature of 250 °C to make molten asphalt uniformly coated on surfaces of the silicon particles, to obtain a silicon-carbon precursor;
(7) subjecting the silicon-carbon precursor to a calcination treatment at 850 °C for 3 hours under nitrogen protection, to obtain a silicon-carbon negative electrode material.

### Comparative Example 5

A preparation method is basically the same as that of Example 1. The difference lies in step (4): the fine grinding treatment is performed by using zirconia beads with a particle size of 0.07 mm at a rotational speed of 3000 r/min, while other conditions remain unchanged. Specifically:
(1) mixing 130 g of a silicon powder (Dv50 is 5 μm) with 1603 g of ethanol, adding a polyoxypropylene-polyoxyethylene copolymer, and conveying the mixture to a nitrogen-blanketed seal tank, and dispersing the mixture for 30 minutes at a rotation speed of 1000 r/min to obtain a first slurry; at this point, a mass content of the silicon powder in the first slurry is 7.5%, and a mass concentration of the polyoxypropylene-polyoxyethylene copolymer is 0.15%;
(2) subjecting the first slurry to standing at 30 °C for 60 minutes to perform an aging treatment, to obtain a second slurry;
(3) conveying the second slurry to a coarse grinding mill, and subjecting the second slurry to a coarse grinding treatment for 8 hours using zirconia beads with a particle size of 0.1 mm, to obtain a third slurry in which silicon particles have a Dv50 of 100 nm; where the coarse grinding treatment is performed at a rotational speed of 3400 r/min and a pressure of 1.2 bar;
(4) conveying the third slurry to an atomizer mill, and subjecting the third slurry to a fine grinding treatment for 8 hours using zirconia beads with a particle size of 0.07 mm, to obtain a fourth slurry in which the silicon particles have a Dv50 of 65 nm and a Dv90 of 99 nm; where the fine grinding treatment is performed at a rotational speed of 3000 r/min and a pressure of 1.7 bar;
(5) dispersing the fourth slurry and 55.7 g of asphalt at a rotational speed of 4000 rpm/min and a pressure of 0.2 bar for 10 minutes to obtain a fifth slurry with a viscosity of 530 cps;
(6) conveying the fifth slurry to a nitrogen-blanketed spray drying tower, and performing a spray drying treatment under conditions of a spray pressure of 0.1 MPa and an inlet air temperature of 250 °C to make molten asphalt uniformly coated on surfaces of the silicon particles, to obtain a silicon-carbon precursor;
(7) subjecting the silicon-carbon precursor to a calcination treatment at 850 °C for 3 hours under nitrogen protection, to obtain a silicon-carbon negative electrode material.

### Comparative Example 6

A preparation method is basically the same as that of Example 1. The difference lies in step (5): the asphalt is changed to a graphite flake, while other conditions remain unchanged.

### Test Example

1. A Malvern 3000 laser particle size analyzer is used to measure Dv50 and Dv90 values of silicon-carbon precursors and silicon-carbon negative electrode materials.

Particle sizes of silicon particles in a slurry are measured using the Malvern 3000 laser particle size analyzer. A specific measurement method is as follows: taking 4 mL of the slurry and diluting to 10 times, then measuring particle sizes, and obtaining particle size classification results of the silicon particles in the slurry, namely values of Dv50 and Dv90.

A BeNano 90 Zeta potential analyzer is used to conduct potential analysis on a slurry. A ground slurry is subjected to a storage stability test. Specifically, the slurry is left to stand for 2 days and 6 days, and then subjected to a particle size test, respectively. A change rate of Dv50 is calculated according to that change rate is equal to (Dv50 of silicon particles in slurry after standing-Dv50 of silicon particles in slurry before standing)/Dv50 of silicon particles in slurry before standing. The test results are shown in Table 2.

### 2. Cycling Performance and Cycling Stability Test

A silicon-carbon negative electrode material from the examples and comparative examples, conductive carbon black (SP), sodium carboxymethyl cellulose (CMC-Na) in a mass ratio of 80:10:10 are mixed with N-methylpyrrolidone (NMP), and then stirred uniformly, to prepare a negative electrode slurry. The negative electrode slurry is coated on a copper foil (with a thickness of 9 μm), with a coating density of 1.6 mg/cm², then subjected to drying and rolling, to obtain a negative electrode sheet (with a thickness of 24 μm and a diameter of 16 mm). The conductive carbon black, used as a SP conductive agent, is purchased from Tianjin Yiborui Chemical Co., Ltd.; the CAS number of sodium carboxymethyl cellulose is 9004-32-4.

Battery Assembly: in a glove box filled with argon gas, a button-type half battery in a specification of CR2032 is assembled. A positive electrode sheet, a separator, and a negative electrode sheet are stacked in sequence to obtain a cell; an aluminum-plastic film is subjected to stamping using a stamping mold; then the cell is encapsulated using the stamped aluminum-plastic film; then is subjected to baking until the moisture is within specification, and is injected with an electrolyte; and forming and secondary sealing are performed, thereby obtaining a button-type battery.

Where, a metal lithium sheet serves as the positive electrode sheet (with a thickness of 1 mm and a diameter of 16 mm), the separator is Celgard 2500 (with a diameter of 18 mm and a thickness of 25 μm) from Keluode, and the electrolyte includes 1 mol/L hexafluorophosphate lithium (LiPF6) electrolyte, with an electrolyte solvent being a mixture of ethylene carbonate (EC), dimethyl carbonate (DMC), and ethyl methyl carbonate (EMC) in a volume ratio of 1:1:1.

Cycling performance test: a New Will test chamber is used for testing, an initial discharge capacity and a first-cycle coulomb efficiency are measured with a voltage range of 0.1-2V and under a condition of 0.1C.

Cycling stability test: cycling is performed under a condition of 0.1C, and the cycle number at which the capacity retention rate reaches 80% is recorded. The test results are shown in Table 3.

TABLE 2

| | | change rate of | change rate of |
|---|---|---|---|
| | Potential | Dv50 after standing | Dv50 after standing |
| Number | value (mV) | for 2 days | for 6 days |
| Example 1 | −30.1 | 1.5% | 2.0% |
| Example 2 | −28.45 | 2.3% | 3.0% |
| Example 3 | −24.32 | 1.9% | 2.8% |
| Example 4 | −22.88 | 2.1% | 3.2% |
| Example 5 | −23.12 | 2.3% | 4.4% |
| Example 6 | −22.42 | 2.8% | 4.3% |
| Example 7 | −30.1 | 1.5% | 2.0% |
| Comparative | −20.16 | 9.6% | 15.2% |
| Example 1 | | | |
| Comparative | −19.18 | 8.8% | 14.3% |
| Example 2 | | | |
| Comparative | −21.83 | 6.6% | 9.0% |
| Example 3 | | | |
| Comparative | −21.68 | 7.0% | 12.4% |
| Example 4 | | | |
| Comparative | −22.14 | 7.5% | 13.7% |
| Example 5 | | | |
| Comparative | −30.1 | 1.5% | 2.0% |
| Example 6 | | | |

It should be noted that in Table 2, the change rates of Dv50 after standing for 2 days and 6 days in Examples 1-7 refer to change rates of Dv50 of the fourth slurry in step (4) after standing for 2 days and 6 days respectively; the change rates of Dv50 after standing for 2 days and 6 days in the Comparative Examples 1-2 refer to change rates of Dv50 of the second slurry in step (2) after standing for 2 days and 6 days respectively; in the Comparative Example 3, the change rates of Dv50 after standing for 2 days and 6 days refer to change rates of Dv50 of the third slurry in step (3) after standing for 2 days and 6 days respectively; the change rates of Dv50 after standing for 2 days and 6 days in the Comparative Examples 4-6 refer to change rates of Dv50 of the fourth slurry in step (4) after standing for 2 days and 6 days respectively.

TABLE 3

| | | | Dv50 of | | Dv90: | | | Cycle |
|---|---|---|---|---|---|---|---|---|
| | Dv50 of | | silicon-carbon | | Dv50 of | Initial | Coulomb | number at |
| | silicon- | | negative | | silicon- | discharge | efficiency | which cycle |
| | carbon | | electrode | | carbon | capacity: | of first | retention |
| Number | precursor | | material | | precursor | mAh/g | circle (%) | rate is 80% |
| Example 1 | 6.9 | μm | 5.8 | μm | 1.42:1 | 2316 | 86% | 450 |
| Example 2 | 10.5 | μm | 8.8 | μm | 1.36:1 | 1712 | 83% | 415 |
| Example 3 | 7.1 | μm | 5.9 | μm | 1.44:1 | 2380 | 84% | 418 |
| Example 4 | 7.0 | μm | 5.8 | μm | 1.49:1 | 2310 | 82.5% | 398 |
| Example 5 | 8.6 | μm | 7.1 | μm | 1.39:1 | 1900 | 83% | 380 |
| Example 6 | 8.7 | μm | 7.3 | μm | 1.4:1 | 1879 | 82.5% | 362 |
| Example 7 | 12.9 | μm | 10.6 | μm | 1.45:1 | 2510 | 87.5% | 420 |
| Comparative | 18.0 | μm | 17.3 | μm | 2.21:1 | 1870 | 79.5% | 286 |
| Example 1 | | | | | | | | |
| Comparative | 17.5 | μm | 16.9 | μm | 2.87:1 | 1650 | 76% | 122 |
| Example 2 | | | | | | | | |
| Comparative | 17.0 | μm | 15.5 | μm | 3.42:1 | 2096 | 80.5% | 286 |
| Example 3 | | | | | | | | |
| Comparative | 16.3 | μm | 15.0 | μm | 1.56:1 | 1645 | 76.2% | 301 |
| Example 4 | | | | | | | | |
| Comparative | 18.2 | μm | 16.2 | μm | 1.68:1 | 1632 | 75.3% | 320 |
| Example 5 | | | | | | | | |
| Comparative | 6.9 | μm | 6.0 | μm | 1.96:1 | 1780 | 78% | 130 |
| Example 6 | | | | | | | | |

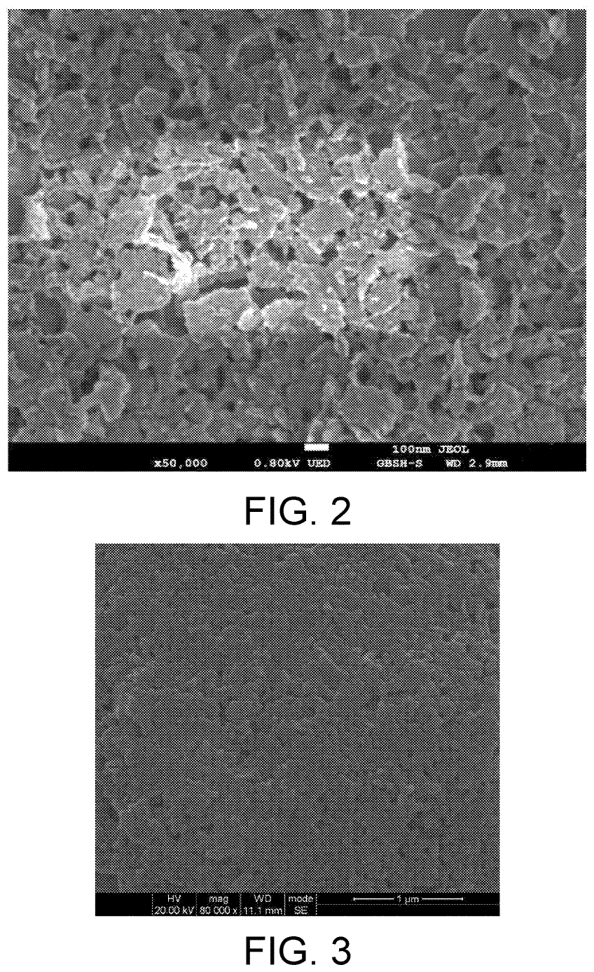

As can be seen from FIGS. 2 and 3, the silicon particles in the slurry of Example 1 have a smaller particle size, and the spacing between the particles is larger, indicating that they are less likely to aggregate; while in the comparative example 1, although the grinding is performed for a longer time, the silicon particles have a larger particle size and the spacing between the particles is smaller, indicating that there is more aggregation.

According to Tables 2 and 3, it can be seen that in the present application, by introducing the polyoxypropylene-polyoxyethylene copolymer and adjusting the specific processes such as the dispersion treatment, aging treatment, coarse grinding treatment, and fine grinding treatment, a slurry with smaller particle size (Dv50 is smaller), narrower particle size distribution (the ratio of Dv90 to Dv50 is smaller), and better stability (the change rate of Dv50 is smaller) may be obtained, and thus the uniformity and electrochemical performance of the silicon-carbon negative electrode material is further improved. This is because in the present application specific parameters of respective processes in the preparation method are specifically matched, resulting in the synergistic effect of respective processes, and thus the comprehensive performance of the silicon-carbon negative electrode material is improved. Even if the grinding is performed for a longer time in the comparative examples than that in the examples, small particle size and narrow particle size distribution cannot be achieved. After research, the inventors find that although the grinding is performed for a longer time, silicon particles with small particle size may also be obtained, but the small-particle-size silicon particles are prone to agglomerate in a short period of time, remaining as silicon particles with larger particle size in the slurry (as shown in FIG. 3).

By comparing Example 1 with Comparative Examples 3-6, it can be seen that the introduction of the polyoxypropylene-polyoxyethylene copolymer, dispersion treatment, aging treatment, coarse grinding treatment, fine grinding treatment, and the introduction of the organic carbon source in the present application have a synergistic effect, and only if they cooperate with each other can the uniformity and electrochemical performance of the silicon-carbon negative electrode material be improved.

According to Table 2, it can be seen that the change rates of Dv50 after the slurry in the examples is left to stand for 2 days and 6 days are much lower than that of the comparative examples, and absolute values of the potential in the examples are much higher than that of the comparative examples. The higher the absolute value of the potential, the more stable the dispersion system of the particles is. This demonstrates that the present application may improve the dispersibility of the silicon particles, improve production efficiency, and maintain the stability of the dispersion of the silicon particles.

According to Table 3, the silicon-carbon negative electrode material provided by the present application exhibits excellent cycling stability and Coulombic efficiency. The battery formed by assembling the negative electrode material has an initial discharge capacity of ≥1879 mAh/g, the first-cycle Coulombic efficiency is ≥82.5%, and cycling is performed for 362 cycles at which the cycle retention rate is 80%.

The above provides a detailed description of the specific embodiments and the experimental verification of the present application. It should be understood that those skilled in the art may make various modifications and variations to the present application based on the concept of the present application without creative effort. Therefore, based on the concept of the present application, any technical solutions that may be obtained by those skilled in the art through logical analysis, deduction or limited experiments within the framework of the existing technology shall be within the protection scope of the present application.

What is claimed is:

1. A preparation method of a silicon-carbon negative electrode material, comprising the following steps:
S1: conveying a silicon powder with a Dv50 of 5 μm, a polyoxypropylene-polyoxyethylene copolymer, and an organic solvent to a nitrogen-blanketed seal tank, and dispersing them for 30 minutes at a rotation speed of 1000-1500 r/min to obtain a first slurry; wherein the organic solvent comprises at least one of ethanol, isopropanol, tert-butanol, ethylene glycol, glycerol, or acetone;
S2: subjecting the first slurry to standing at 30-40 °C for 20-60 minutes to perform an aging treatment, to obtain a second slurry;
S3: conveying the second slurry to a coarse grinding mill, and subjecting the second slurry to a coarse grinding treatment for 5-10 hours using zirconia beads with a particle size of 0.1-0.2 mm, to obtain a third slurry; wherein the coarse grinding treatment is performed at a rotational speed of 3000-3400 r/min and a pressure of 1.1-1.2 bar; and silicon particles in the third slurry have a Dv50 of 100-120 nm;
S4: conveying the third slurry to an atomizer mill, and subjecting the third slurry to a fine grinding treatment for 5-10 hours using zirconia beads with a particle size of 0.03-0.05 mm, to obtain a fourth slurry; wherein the fine grinding treatment is performed at a rotational speed of 2000-2500 r/min and a pressure of 1.3-1.7 bar; the silicon particles in the fourth slurry have a Dv50 of 50-60 nm; and a ratio of Dv90 to Dv50 of the silicon particles in the fourth slurry is (1.35-1.5):1;
S5: dispersing a material comprising the fourth slurry and an organic carbon source at a rotational speed of 3500-4000 rpm/min and a pressure of 0.2-0.3 bar for 10 minutes to obtain a fifth slurry with a viscosity of 400-500 cps; wherein the organic carbon source comprises at least one of asphalt, polyacrylonitrile, polyvinylpyrrolidone, phenolic resin, or epoxy resin;
S6: conveying the fifth slurry to a nitrogen-blanketed spray drying tower, and performing a spray drying treatment under conditions of a spray pressure of 0.01-0.1 MPa and an inlet air temperature of 200-300 °C to make molten organic carbon source uniformly coated onto surfaces of the silicon particles, to obtain a silicon-carbon precursor; wherein the silicon-carbon precursor has a Dv50 of 6-14.4 μm;
S7: subjecting the silicon-carbon precursor to a sintering treatment at 800-900 °C for 2.5-3.5 hours, to obtain a silicon-carbon negative electrode material; wherein the silicon-carbon negative electrode material has a Dv50 of 5-12 μm, and a ratio of Dv90 to Dv50 of the silicon-carbon negative electrode material is (1.36-1.49):1;
wherein Dv50 represents a particle size at which a cumulative volume fraction reaches 50%, and Dv90 represents a particle size at which the cumulative volume fraction reaches 90%.

2. The preparation method of a silicon-carbon negative electrode material according to claim 1, wherein in the first slurry, based on that a total mass of the first slurry is 100% by mass, a content of the silicon powder is 5.5%-15% by mass;
in the first slurry, based on that a total mass of the first slurry is 100% by mass, a content of the polyoxypropylene-polyoxyethylene copolymer is 0.15%-1.5% by mass; and
a mass ratio of the silica powder to the organic carbon source is (3-7):(3-7).

3. The preparation method according to claim 1, wherein an outlet temperature of the spray drying is 60-80 °C.

4. The preparation method of a silicon-carbon negative electrode material according to claim 2, wherein an outlet temperature of the spray drying is 60-80 °C.

5. The preparation method of a silicon-carbon negative electrode material according to claim 1, wherein after the sintering treatment, the preparation method further comprises a pulverizing treatment and a sieving treatment.

6. The preparation method of a silicon-carbon negative electrode material according to claim 1, wherein in the step S5, the material further comprises carbon nanotubes.

7. The preparation method of a silicon-carbon negative electrode material according to claim 6, wherein a mass ratio of the carbon nanotubes to the organic carbon source is 1:(1-2).

8. The preparation method of a silicon-carbon negative electrode material according to claim 1, wherein a weight average molecular weight of the polyoxypropylene-polyoxyethylene copolymer is 1000-1500.

9. The preparation method of a silicon-carbon negative electrode material according to claim 1, wherein after the fourth slurry is left to stand for 2 days, a change rate of Dv50 of the fourth slurry is not higher than 3%; and after the fourth slurry is left to stand for 6 days, the change rate of Dv50 of the fourth slurry is not higher than 5%.

10. A silicon-carbon negative electrode material, obtained by the preparation method according to claim 1.

11. The silicon-carbon negative electrode material according to claim 10, wherein in the first slurry, based on that a total mass of the first slurry is 100% by mass, a content of the silicon powder is 5.5%-15% by mass;
in the first slurry, based on that a total mass of the first slurry is 100% by mass, a content of the polyoxypropylene-polyoxyethylene copolymer is 0.15%-1.5% by mass; and
a mass ratio of the silica powder to the organic carbon source is (3-7):(3-7).

12. The silicon-carbon negative electrode material according to claim 10, wherein an outlet temperature of the spray drying is 60-80 °C.

13. The silicon-carbon negative electrode material according to claim 10, wherein after the sintering treatment, the preparation method further comprises a pulverizing treatment and a sieving treatment.

14. The silicon-carbon negative electrode material according to claim 10, wherein in the step S5, the material further comprises carbon nanotubes.

15. The silicon-carbon negative electrode material according to claim 10, wherein a mass ratio of the carbon nanotubes to the organic carbon source is 1:(1-2).

16. The silicon-carbon negative electrode material according to claim 10, wherein a weight average molecular weight of the polyoxypropylene-polyoxyethylene copolymer is 1000-1500.

17. The silicon-carbon negative electrode material according to claim 10, wherein after the fourth slurry is left to stand for 2 days, a change rate of Dv50 of the fourth slurry is not higher than 3%; and after the fourth slurry is left to stand for 6 days, the change rate of Dv50 of the fourth slurry is not higher than 5%.

18. A battery, comprising the silicon-carbon negative electrode material according to claim 10.
